(19) United States
(12) Patent Application Publication
(10) Pub. No.: US 2011/0195223 A1
(43) Pub. Date: Aug. 11, 2011

(54) Asymmetric Front/Back Solder Mask

(75) Inventors: Omar J. Bchir, San Diego, CA (US); John P. Holmes, San Diego, CA (US); Edward Reyes, San Diego, CA (US)

(73) Assignee: QUALCOMM INCORPORATED, San Diego, CA (US)

(21) Appl. No.: 12/703,821

(22) Filed: Feb. 11, 2010

(51) Int. Cl. B32B 3/24; B05D 5/00

(52) U.S. Cl. 428/138; 427/98.4

(57) ABSTRACT

A substrate including a die side interconnect pattern having a first solder mask thickness, and a board side interconnect pattern having a second solder mask thickness, where the second thickness is greater than the first thickness. Fabrication process using dry film solder mask can apply a first laminate thickness forming a die side solder mask, and a second laminate thickness forming a board side solder mask; the second thickness being greater than the first thickness. Fabrication process using a liquid solder resist can apply a first number of passes of solder resist forming a die side solder mask, and a second number of passes of solder resist forming a board side solder mask, where the board side thickness is greater than the die side thickness.

### FIELD OF DISCLOSURE

The present disclosure relates generally to solder masks used for integrated circuits, and more specifically to solder masks used on a substrate for coupling a flip chip die to a printed circuit board.

### BACKGROUND

A solder mask is typically a lacquer like layer of polymer that provides a protective coating for the metal traces of a printed circuit board (PCB). The solder mask also prevents solder from bridging between conductors, thereby preventing short circuits. The solder mask can be applied to substrates through the use of a liquid-type solder resist or a dry film-type solder resist. The liquid-type solder resist can be applied by a number of methods, including screen printing and roll coating. The dry film-type solder resist is typically applied by a lamination process. A liquid photo-imageable solder resist can be applied to the PCB, and then exposed to a pattern and developed to provide openings in the pattern for parts to be soldered to copper pads. A dry film photoimageable solder resist can be vacuum laminated on the PCB, and then exposed and developed. Laser ablatable solder resist can be applied to the PCB, and then portions removed by lasing with a laser beam.

Flip Chip-Chip Scale Package substrates use the same thickness of solder mask on the front side of the substrate (die attach side) and the back side of the substrate (board attach side). A flip chip die is attached to the substrate on the front side or die side of the substrate. The substrate is attached to the circuit board on the back side or board side. A ball grid array (BGA) is typically used for attaching the substrate to the board. One of the reasons for using symmetric (same thickness) solder masks on both sides of the substrate is to match the coefficient of thermal expansion on both sides of the substrate. Having asymmetric solder mask thickness (thicker solder mask on one side) can worsen the imbalance in the coefficient of thermal expansion on either side of the core, and can exacerbate substrate warpage issues.

However, a symmetric solder mask is a compromise between flip chip attach yields (die side) and BGA joint reliability (board side). A thicker solder mask on the die side can limit the process window for flip chip attach, but a thicker solder mask on the board side can provide less stress to the BGA intermetallic interface which can improve solder joint reliability. A thinner solder mask on the die side improves the window for chip attach, but a thinner solder mask on the board side causes higher stress at the intermetallic-solder interface in the BGA joint which can degrade drop test performance and reliability. For these reasons, it would be desirable to have an asymmetric solder mask with a thinner solder mask on the die side to widen the process window for chip attach, and a thicker solder mask on the board or BGA side for enhanced drop performance and reliability.

### SUMMARY

Implementing asymmetric solder mask thicknesses on the die side and board side of the substrate can eliminate the flip chip attach yield vs. BGA reliability compromise. Optimizing solder mask thickness on the front and back side of the substrate independently can provide an enhanced chip attach process window and robust BGA solder joint reliability.

A substrate is disclosed that has a die side interconnect having a first solder mask with a first thickness, and a board side interconnect having a second solder mask with a second thickness, where the second thickness is greater than the first thickness. The first and second solder masks can be formed using different types of solder resist, including a liquid photoimageable solder resist, a dry film photoimageable solder resist, and a laser ablatable solder resist. The thickness of the first solder mask can be about 10 μm or alternatively the thickness of the first solder mask can be in the range of about 10 μm to about 15 μm. The thickness of the second solder mask can be about 30 μm, or alternatively the thickness of the first solder mask can be greater than 20 μm. The first solder mask can be formed using one of a liquid solder resist and a dry film solder resist, and the second solder mask can be formed using the other of a liquid solder resist and a dry film solder resist. The first solder mask can be formed using a laser ablatable solder resist, and the second solder mask can be formed using a photoimageable solder resist.

A fabrication process using a dry film solder resist can be used to apply a first incoming laminate thickness to form a first solder mask on a die side of a substrate, and to apply a second incoming laminate thickness to form a second solder mask on a board side of the substrate, where the second incoming dry film thickness is greater than the first incoming dry film thickness. The process may also be done in the reverse order. The first incoming laminate thickness can be about 10 μm, or alternatively can be in the range of about 10 μm to about 15 μm. The second incoming laminate thickness can be about 30 μm, or alternatively can be greater than 20 μm.

A fabrication process using a liquid solder resist coating can be used to apply a first number of passes of the liquid solder resist coating to form a first solder mask having a first thickness on a die side of a substrate, and to apply a second number of passes of the liquid solder resist coating to form a second solder mask having a second thickness on a board side of a substrate, where the second number of passes is greater than the first number of passes and the second thickness is greater than the first thickness. The first number of passes can be performed to form the first solder mask with the first thickness of about 10 μm, or alternatively to form the first solder mask with the first thickness in the range of about 10 μm to about 15 μm. The second number of passes can be performed to form the second solder mask with the second thickness of about 30 μm, or alternatively to form the second solder mask with the second thickness greater than 20 μm.

For a more complete understanding of the present disclosure, reference is now made to the following detailed description and the accompanying drawings.

### BRIEF DESCRIPTION OF THE DRAWINGS

FIG. 1 is a portion of a cross-section of a substrate and a flip chip, the substrate having a ball grid array on a board side and flip chip attachment windows on a die side;

FIG. 2 is a portion of a cross-section of a substrate having a die side attached to a flip chip and having a board side with a ball grid array, the solder mask being thick and symmetric on both the die side and the board side;

FIG. 3 is a portion of a cross-section of a substrate having a die side attached to a flip chip and having a board side with a ball grid array, the solder mask being thin and symmetric on both the die side and the board side;

FIG. 4 is a portion of a cross-section of a substrate having a die side attached to a flip chip and having a board side with a ball grid array, the solder mask being asymmetric, thinner on the die side and thicker on the board side; and

FIG. 5 is a block diagram showing an exemplary wireless communication system in which a substrate having an asymmetric solder mask may be advantageously employed.

### DETAILED DESCRIPTION

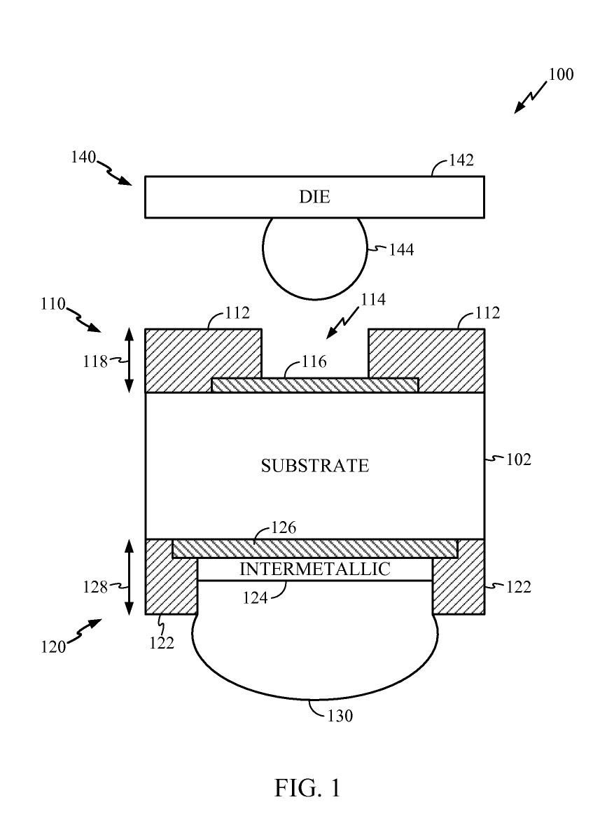

FIG. 1 illustrates a cross-section of a portion of a flip chip-chip scale package which includes an underlying chip 100 and a flip-chip 140. The underlying chip 100 includes a substrate 102 that has a front side or die side 110 and a back side or board side 120. A solder resist pattern is deposited on the die side 110 of the substrate 102 to form a die side interconnect pattern 112 which includes a solder resist layer having a plurality of attachment windows 114 for the attachment of the flip chip 140 to the substrate 102. An attachment pad 116 is coupled to the substrate 102 at the base of each attachment window 114 of the die side interconnect pattern 112. The die side interconnect pattern 112 has a thickness 118. A solder resist pattern is deposited on the board side 120 of the substrate 102 to form a board side interconnect pattern 122 which includes a solder resist layer that interfaces with a ball grid array (BGA). A BGA solder ball 130 is located in each connection point of the board side interconnect pattern 122. A connection pad 126 is coupled to the substrate 102 at the base of each connection point of the board side interconnect pattern 122, and an intermetallic layer 124 is positioned between the connection pad 126 and the BGA solder ball 130. The board side interconnect pattern 122 has a thickness 128. As is known to those of skill in the art, the die side interconnect pattern 112 includes a plurality of attachment windows 114 formed on the die side 110 of the substrate 102 for attachment of the flip-chip 140; and the board side interconnect pattern 122 includes a plurality of connection points with BGA solder balls 130 formed on the board side 120 of the substrate 102 for attachment to a circuit board, but only an exemplary one of each is shown here for clarity.

The flip-chip 140 includes a die 142 and a flip-chip (FC) solder bump 144. When the flip-chip 140 is attached to the substrate 102, the FC solder bump 144 should fit within the attachment window 114 of the die side interconnect pattern 112 of the substrate 102 to form an electrical connection between the substrate 102 and the flip chip 140. As is known to those of skill in the art, the flip-chip 140 has a plurality of FC solder bumps 144 formed on the flip chip die 142 for connection to the die side interconnect pattern 112 of the substrate 102, but only an exemplary one is shown here for clarity.

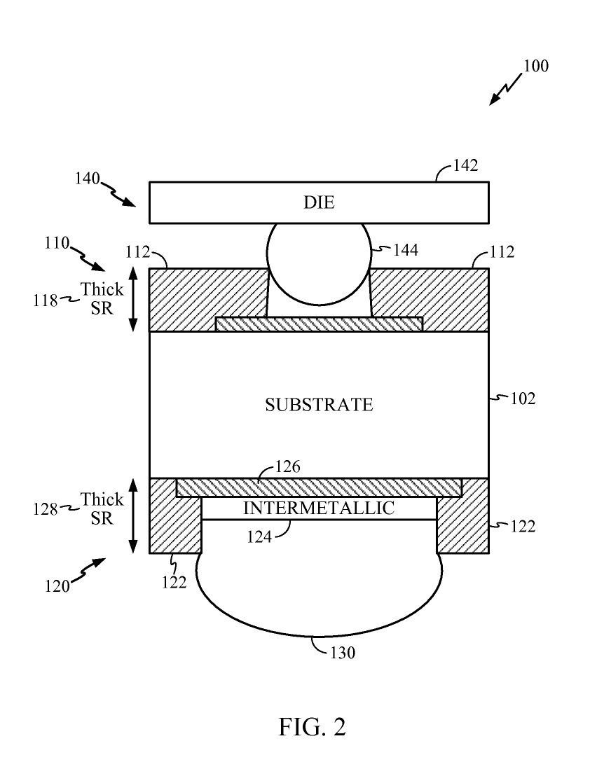

FIG. 2 illustrates the connection of the substrate 102 and the flip-chip 140 when the thickness of the solder resist on both sides of the substrate is substantially equal (symmetric solder mask) and thick. The thickness 118 of the die side interconnect pattern 112 is substantially equal to the thickness 128 of the board side interconnect pattern 122 and both are relatively thick, for example 30 μm. On the board side 120 of the substrate 102, the thick solder resist of the board side interconnect pattern 122 helps support the BGA solder ball 130 which puts less stress on the interface between the BGA solder ball 130 and the intermetallic layer 124 which should improve drop test performance and reliability. However, on the die side 110 of the substrate 102, the thick solder resist of the die side interconnect pattern 112 can limit the attachment window 114 which can interfere with the connection between the substrate 102 and the flip-chip 140 decreasing the flip-chip attachment yield. In some cases, there can actually be a physical constraint where either the FC solder bump 144 cannot fit in the attachment window 114, or the FC solder bump 144 does not touch the attachment pad 116 when it is in the attachment window 114. Thus, having symmetric and thick solder resist for both the die side interconnect pattern 112 and the board side interconnect pattern 122, can improve BGA reliability but can also degrade attachment yields between the substrate 102 and the flip-chip 140.

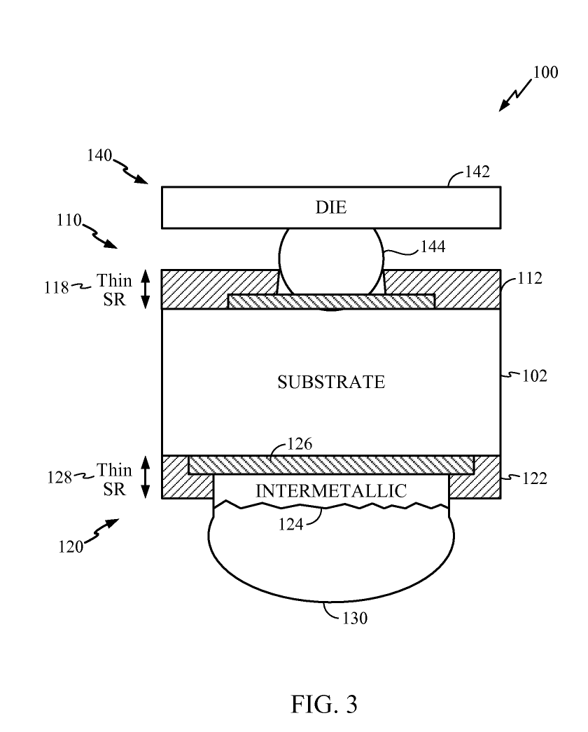

FIG. 3 illustrates the connection of the underlying chip 100 and the flip-chip 140 when the thickness of the solder mask on both sides of the substrate is substantially equal (symmetric solder mask) and thin. The thickness 118 of the die side interconnect pattern 112 is substantially equal to the thickness 128 of the board side interconnect pattern 122, and both are relatively thin, for example 10 μm. On the die side 110 of the substrate 102, the thin solder resist of the die side interconnect pattern 112 improves the geometry of the attachment window 114 to make a good connection between the substrate 102 and the flip-chip 140 which increases the flip-chip attachment yield. However, on the board side 120 of the substrate 102, the thin solder resist of the board side interconnect pattern 122 does not help support the BGA solder ball 130 which puts greater stress on the interface between the BGA solder ball 130 and the intermetallic layer 124 which can decrease solder joint reliability. This is especially problematic for products which route input/output signals through the corner-most BGA balls where solder balls near the corner of the substrate and board tend to experience the highest solder joint stress and therefore break first. Thus, having symmetric and thin solder resist for both the die side interconnect pattern 112 and the board side interconnect pattern 122, can improve attachment yields between the substrate 102 and the flip-chip 140, but can also cause premature failure of the BGA attachment in drop-shock tests due to stress at the interface between the BGA solder ball 130 and the intermetallic layer 124.

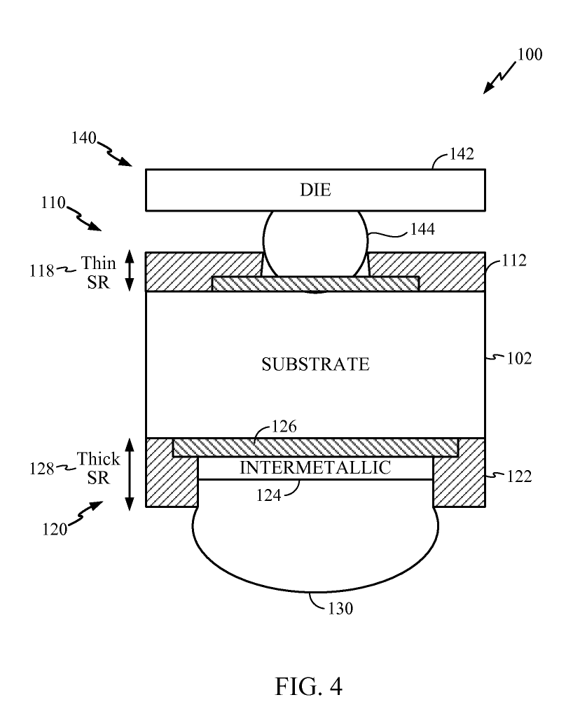

FIG. 4 illustrates the connection of the substrate 102 and the flip-chip 140 when the thickness of the solder resist on both sides of the substrate is not equal (asymmetric solder mask). The thickness 118 of the solder resist of the die side interconnect pattern 112 is thinner than the thickness 128 of the solder resist of the board side interconnect pattern 122. On the die side 110 of the substrate 102, the thin solder resist of the die side interconnect pattern 112 improves the geometry of the attachment window 114 to make a good connection between the substrate 102 and the flip-chip 140. On the board side 120 of the substrate 102, the thick solder resist of the board side interconnect pattern 122 helps support the BGA solder ball 130 which puts less stress on the interface between the BGA solder ball 130 and the intermetallic layer 124 which improves reliability. Thus, an asymmetric solder mask thickness, a thinner die side interconnect pattern 112 and thicker board side interconnect pattern 122, can both improve attachment yields between the substrate 102 and the flip-chip 140 and reduce solder joint stress on the interface between the BGA solder ball 130 and the intermetallic layer 124 to improve drop test performance and reliability.

One common justification for having symmetric solder mask thickness on the die and board sides of the substrate is concern about balancing the coefficient for thermal expansion (CTE) on opposing sides of the substrate. Balancing the CTE in the x-y dimension for the die and board side of the substrate helps control strip and unit level warpage, which can have an impact on board mount yield. Substrate designs are inherently unbalanced from a CTE standpoint due to the die side having a greater degree of routing, including many traces, which divides the copper planes on the die side. This results in a lower copper to dielectric material volume ratio on the die side relative to the board side of the substrate. Since the CTE of Cu (17 ppm) is higher than the x-y CTE of the core/prepreg (typically 13 ppm), the lower Cu density on the die side of the substrate can cause the effective CTE of the die side to be lower than the board side, which can be a warpage concern. Being able to independently control solder resist thickness (solder resist CTE typically ≧40 ppm) on the die side and the board side of the substrate enables a better balancing of the effective CTEs and can therefore alleviate the warpage concern.

Tests have shown that flip-chip attachment yields are improved when the solder mask thickness of the die side interconnect pattern is about 10 μm to 15 μm. Representative drop test data suggests that use of a 10 μm board side solder mask thickness can reduce the number of drops to first failure by 65-70% relative to a solder mask thickness of 20-30 μm.

Solder resist can be applied to substrates to form interconnect patterns through the use of a liquid-type resist or a dry film-type resist. The liquid-type resist can be applied by a number of methods, including screen printing and roll coating. A liquid photoimageable solder resist, such as Taiyo AUS320, can be applied in one or more coatings to obtain the desired thickness of the interconnect. Thus, more coatings can be applied to one side of the substrate than the other to obtain asymmetric interconnect thicknesses. The dry film-type resist is typically applied by a lamination process. A dry film photoimageable solder resist, such as Taiyo AUS410, can be applied to form an interconnect using a laminate of the desired thickness. Thus a laminate of one thickness can be applied to one side of the substrate and a laminate of another thickness can be applied to the other side of the substrate to obtain asymmetric interconnect thicknesses. Laser ablation type solder resist, such as Taiyo S500, may be applied in one or more coatings to achieve the desired interconnect thickness on each side of the substrate.

Different types of solder resist can be applied to the different sides of the substrate. If desired, a liquid resist could be applied to one side of the substrate and a dry film resist to the opposite side. Alternatively, laser ablation type solder resist could be applied to one side of the substrate while a photoimageable resist could be used on the opposite side. A combination of laser ablation solder mask on the die side and photoimageable resist on the BGA side may be a desirable combination. The laser ablation solder mask on the die side facilitates tight solder resist opening alignment to the underlying pads, while the photoimageable resist on the BGA side opens larger diameter BGA solder resist openings for high throughput.

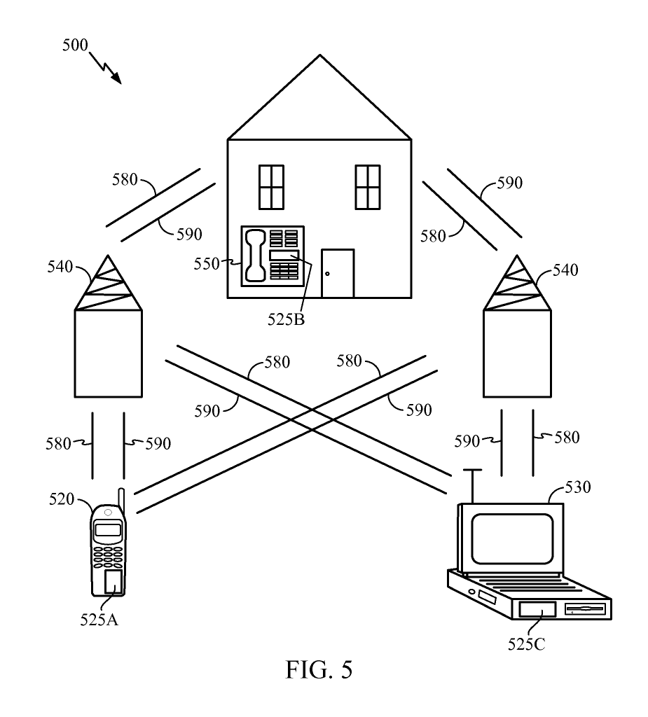

FIG. 5 shows an exemplary wireless communication system 500 in which an embodiment of a substrate with an asymmetric solder mask or interconnect pattern may be advantageously employed. One side of the substrate can have a thicker solder mask, for example to provide improved BGA reliability, and the other side of the substrate can have a thinner solder mask, for example to provide improved flip-chip attachment yields. For purposes of illustration, FIG. 5 shows three remote units 520, 530, and 550 and two base stations 540. It should be recognized that typical wireless communication systems may have many more remote units and base stations. Any of remote units 520, 530, and 550 may include components having asymmetric solder mask thicknesses as disclosed herein. FIG. 5 shows forward link signals 580 from the base stations 540 and the remote units 520, 530, and 550 and reverse link signals 590 from the remote units 520, 530, and 550 to base stations 540.

In FIG. 5, remote unit 520 is shown as a mobile telephone, remote unit 530 is shown as a portable computer, and remote unit 550 is shown as a fixed location remote unit in a wireless local loop system. For example, the remote units may be cell phones, hand-held personal communication systems (PCS) units, portable data units such as personal data assistants, or fixed location data units such as meter reading equipment. Although FIG. 5 illustrates certain exemplary remote units that may include components having asymmetric solder mask thicknesses as disclosed herein, the use of asymmetric solder mask thicknesses is not limited to these exemplary illustrated units. Embodiments may be suitably employed in any electronic device in which asymmetric solder mask thicknesses as disclosed herein is desired.

While exemplary embodiments incorporating the principles of the present invention have been disclosed hereinabove, the present invention is not limited to the disclosed embodiments. Instead, this application is intended to cover any variations, uses, or adaptations of the invention using its general principles. Further, this application is intended to cover such departures from the present disclosure as come within known or customary practice in the art to which this invention pertains and which fall within the limits of the appended claims.

We claim:

1. A substrate comprising:
a die side interconnect pattern having a first solder mask with a first thickness; and
a board side interconnect pattern having a second solder mask with a second thickness, the second thickness being greater than the first thickness.

2. The substrate of claim 1, wherein the first solder mask is formed using a solder resist selected from the group consisting of a liquid photoimageable solder resist, a dry film photoimageable solder resist and a laser ablatable solder resist.

3. The substrate of claim 1, wherein the second solder mask is formed using a solder resist selected from the group consisting of a liquid photoimageable solder resist, a dry film photoimageable solder resist and a laser ablatable solder resist.

4. The substrate of claim 1, wherein the first solder mask and the second solder mask are formed using the same type of solder resist.

5. The substrate of claim 1, wherein the first solder mask is formed using one of a liquid solder resist and a dry film solder resist, and the second solder mask is formed using the other of a liquid solder resist and a dry film solder resist.

6. The substrate of claim 1, wherein the first solder mask is formed using a laser ablatable solder resist, and the second solder mask is formed using a photoimageable solder resist.

7. The substrate of claim 1, wherein the first thickness is in the range of about 10 μm to about 15 μm.

8. The substrate of claim 1, wherein the second thickness is greater than or equal to 20 μm.

9. The substrate of claim 1, wherein the first thickness is about 10 μm and the second thickness is about 30 μm.

10. The substrate of claim 1, wherein the first thickness is in the range of about 10 μm to about 15 μm, and the second thickness is in the range of about 20 μm to about 30 μm.

11. A fabrication process using a dry film solder mask, the fabrication process comprising:
applying a first incoming laminate thickness to form a first solder mask on a die side of a substrate; and
applying a second incoming laminate thickness to form a second solder mask on a board side of the substrate, the second incoming dry film thickness being greater than the first incoming dry film thickness.

12. The fabricating process of claim 11, wherein the first incoming laminate thickness is about 10 μm.

13. The fabricating process of claim 11, wherein the first incoming laminate thickness is in the range of about 10 μm to about 15 μm.

14. The fabricating process of claim 11, wherein the second incoming laminate thickness is about 30 μm.

15. The fabricating process of claim 11, wherein the second incoming laminate thickness is greater than or equal to 20 μm.

16. A fabrication process using a liquid solder resist coating, the fabrication process comprising:
applying a first number of passes of the liquid solder resist coating to form a first solder mask having a first thickness on a die side of a substrate; and
applying a second number of passes of the liquid solder resist coating to form a second solder mask having a second thickness on a board side of a substrate, the second number of passes being greater than or equal to the first number of passes, the second thickness being greater than the first thickness.

17. The fabricating process of claim 16, wherein the first number of passes is performed to form the first solder mask with the first thickness of about 10 μm.

18. The fabricating process of claim 16, wherein the first number of passes is performed to form the first solder mask with the first thickness in the range of about 10 μm to about 15 μm.

19. The fabricating process of claim 16, wherein the second number of passes is performed to form the second solder mask with the second thickness of about 30 μm.

20. The fabricating process of claim 16, wherein the second number of passes is performed to form the second solder mask with the second thickness greater than or equal to 20 μm.
